(19) United States
(12) Patent Application Publication
(10) Pub. No.: US 2006/0182586 A1
(43) Pub. Date: Aug. 17, 2006

(54) Lifter device for displacement of an article

(76) Inventor: Olav Lauvdal, Marnadal (NO)

Correspondence Address: CHRISTIAN D. ABEL, ONSAGERS AS, POSTBOKS 6963 ST. OLAVS PLASS, NORWAY, N-0130, NO

(21) Appl. No.: 10/562,632

(22) PCT Filed: Jun. 29, 2004
(86) PCT No.: PCT/NO04/00196

§ 371 Date: Mar. 22, 2006

(30) Foreign Application Priority Data
Jun. 30, 2003 (NO) 20033009
Aug. 13, 2003 (NO) 20033598

(51) Int. Cl. B66F 9/18

(52) U.S. Cl. 414/623

(57) ABSTRACT

A device for mounting on an implement carrier such as a fork lift truck, hoisting crane or the like in order to move, hold or lift an object. The device comprises—a carrier part which is mounted on the implement carrier preferably by the carrier part being in the form of a sleeve which is inserted on the implement carrier's fork structure, and—a holding part which is attached to the carrier part, the holding part being provided with at least one securing device with characteristics that make it possible to secure an object by contact between at least one of the object's surfaces and the securing device,—a trigger that ensures that the forces acting between the object's surface and the securing device are broken or discontinued, thus releasing the object.

The invention relates to a holding device for mounting on an implement carrier such as a fork lift truck, hoisting crane, tractor or the like in order to move, hold or lift an object.

The object of the invention is to provide a device which can be used in connection with moving or holding an object, where only one of the object's surfaces is accessible as a gripping/lifting surface.

Such a device will be particularly useful where several objects are stacked on top of one another in such a fashion that it is difficult or even impossible to obtain a conventional, encircling grip of the individual object, since only one of the object's surfaces is accessible as a possible gripping surface.

The device according to the invention will therefore be suitable for a range of applications, but will be particularly relevant in connection with moving discarded white goods. In the course of time the demand has increased for recycling or special treatment of white goods such as refrigerators and cookers, resulting in an accumulation of white goods at the dealers' receiving stations. The white goods are often tightly stacked on top of one another in great quantities. For refuse disposal companies that have to collect the white goods and depend on fast removal of the discarded white goods, it is a major challenge to have the tightly-stacked white goods transferred to the lorry in a fast and efficient manner. Standard implement carriers such as fork lift trucks are not suited to this purpose, since there is often little or no room for the truck's gripping parts due to the tight stacking.

Thus there is a great need to provide a device which is designed so as to permit the transfer of the object even though only one of the object's surfaces/sides is accessible as a gripping surface. When the device has to be employed in connection with moving an item of white goods, for example, one of the sides or the top surface of the item viewed in relation to the individual item's position in the stack may be relevant gripping surfaces for the device.

Such an invention is provided by the device as it is set out in the independent patent claim. Further embodiments of the invention are set out in the following dependent patent claims.

The device according to the invention comprises:

A carrier part which is mounted on the implement carrier preferably by the carrier part being in the form of a sleeve that is inserted in suitable parts of the implement carrier. For example, a fork structure such as a truck's fork will be well suited for mounting the carrier part. The device further comprises a holding part which, for example, may be attached to the carrier part in a substantially vertical orientation.

The holding part is provided with at least one securing device with characteristics that enable it to secure an object by contact between at least one of the object's surfaces and the securing device. The holding forces from the securing device(s) thereby essentially provide the holding capacity for the device according to the invention. The size of the securing device's contact surface is adapted to suit the specific tasks.

A trigger which is included in the device breaks the forces between the object's surface and the securing device, thus releasing the object from the holding device.

With the device a grip can therefore be established between one of the surfaces of the object that has to be moved and the actual device. The device in question with the object secured can be moved to the desired location and the trigger can be employed to release the object at the new location.

According to a preferred embodiment of the invention the object that has to be moved, held or lifted is an object with a surface that has at least some smooth portions or an object that is composed of thin metal sheets, for example of the white goods type. It should be mentioned here that other types of objects such as cardboard boxes,windows, building surfaces may be suitable objects for the device according to the invention to move, hold or lift.

If the object that has to be moved/held is composed of thin metal sheets and/or is an item of white goods such as a refrigerator, washing machine, etc., the securing device may be comprised of one or more electromagnets or permanent magnets, or a combination thereof.

Alternatively, the securing device may be composed of suction cups or similar devices that can create negative pressure. Equipped with suction cups with negative pressure, the invention will be able to be used for installation of, for example, windows, window panes and wallboards. By means of a vacuum generator that generates negative pressure in the suction cups, sufficient holding power is developed for the various objects that have to be handled. The size and number of suction cups and their nature and design will vary according to what has to be lifted or handled. An energy-saving fuction is mounted on the vacuum system in order to reduce the energy consumption since the yoke is mainly built for mobile use.

When installing objects such as window panes or wallboards, it will be possible to remove them from the top lying in a horizontal position. When they are securely gripped by vacuum suction cups, the board or window pane can be swung into the desired position either manually or by means of an actuator. The actuator may, for example, be a pneumatic, hydraulic or electric actuator. The objects are then transported to the mounting point. They are driven by vacuum ejectors (compressed air-driven vacuum pumps) and in addition a vacuum generator with associated control systems is mounted. The size of the latter depends on the air consumption and the user's requirement regarding how many lifts should be performed before recharging the compressed air tank. The compressed air tank may also be connected to a compressor for continuous operation. The compressor may be driven by an electromotor with its own batteries mounted on the yoke, or by an internal combustion engine or a hydraulic motor. It is also possible to mount electrically-operated vacuum pumps on each suction cup.

In an embodiment the trigger employed for releasing the object may be a guide part which is rotatably mounted in the holding part. The guide part is rotated, thus pushing the object away from the securing device by means of the rotating motion to a distance that is sufficient for the forces between the object and the securing device to decrease and the object is released from the holding device. When using permanent magnets, the guide part pushes the object away from the contact surface, with the result that the object is moved beyond the permanent magnets'effective range of influence. Alternatively, the trigger may be designed so as to break the voltage to the electromagnets by interrupting the current supply, thus causing the magnets to lose their holding power, or causing the negative pressure to be discontinued, thus releasing the object.

In a second embodiment the trigger may be a spring-loaded device which causes the distance between the securing device and the object to increase, thus releasing the object. A spring-loaded device of this kind can be stretched by a hydraulic force, for example from an actuator or by the forks of a fork lift truck being moved from one position to another. When the forks are in a projecting position the trigger may be in a position where the object is released, or the trigger may be in a position where the object is secured.

If the device according to the invention is attached to an implement carrier such as a truck or the like with telescopable fork, a fixed connection can be established, such as, for example, a securely connected line between a stationary part of the fork and the guide part. When the fork is fully extended telescopically, this will cause the guide part to be rotated and the object released. Alternatively, in addition to the line, the guide part may be provided with a spring element. In an embodiment of the invention the guide part will be rotated and the object released when the forks are in a retracted state. When the forks are telescoped outwards towards a projecting position, the line and spring element arrangement will ensure that the guide part is held in a position where the object is secured relative to the securing device. This will be described in greater detail in the detailed description of the figures.

Alternatively, the trigger may be operated manually or by means of an actuator. The actuator may, for example, be a pneumatic, hydraulic or electric actuator.

As additional equipment one or more supporting edges may be permanently or removably mounted in the lower edge of the holding part. The supporting edge may be employed as an extra holding/lifting device in addition to the holding force from the securing devices. If there is no room for the supporting edge due to the size of the object that has to be lifted, the supporting edge can be removed. The resulting reduction in holding force is compensated by increased holding force from the securing device, for example in the form of an augmented magnetic field. A stronger or augmented magnetic field is achieved by means of more or stronger magnets.

The holding part may be rotatably or preferably hingedly mounted on the carrier part, thus enabling the holding part to be moved to another desired position and fixed in this new position. In an embodiment the holding part is oriented in a vertical position so that the securing device's contact surface is standing in a vertical position, but the holding part can also be moved forwards to a horizontal position in order to be able to grip surfaces from the top.

The device according to the invention can be designed to be collapsible. Thus the device may, for example, be folded up by the holding part being moved backwards to abut against the, carrier part.

A preferred embodiment of the invention will now be described in detail in association with the figures.

FIG. 1 is a side view of the device according to an embodiment of the invention.

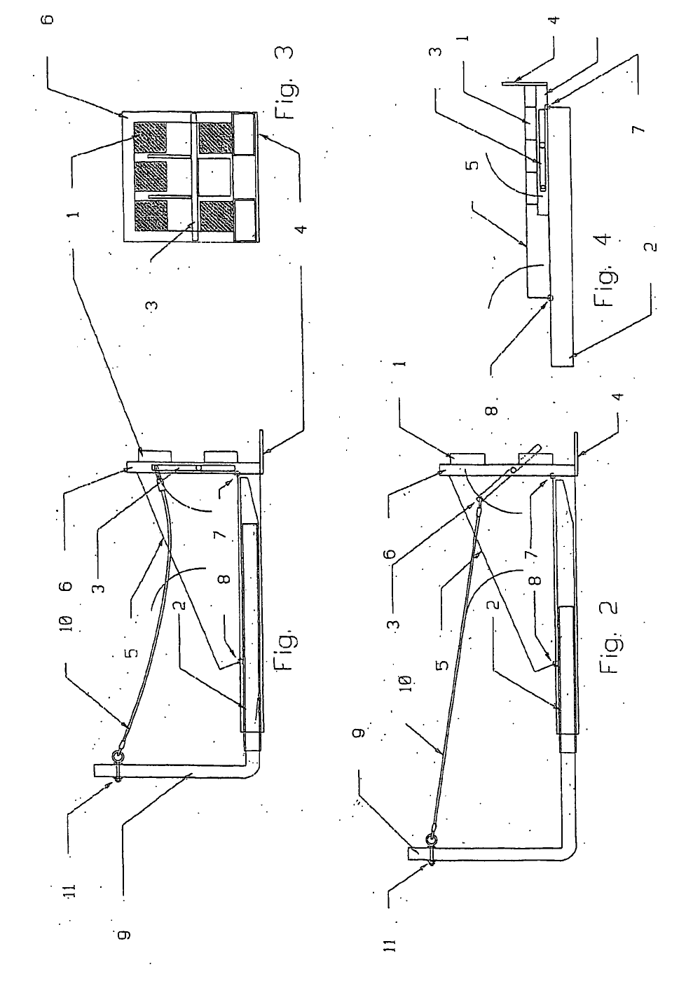

FIG. 2 also views the device from the side, in this case with the trigger moved into a rotated position.

FIG. 3 is a front view of the holding part with securing devices.

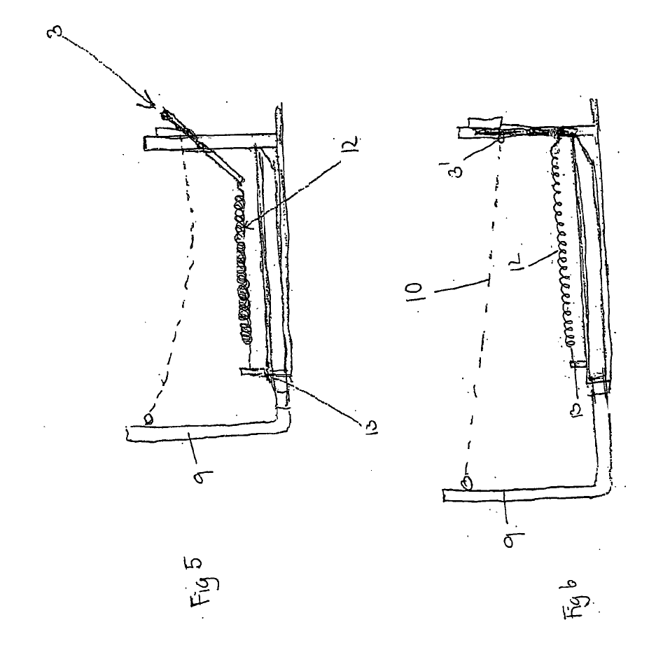

FIG. 4 illustrates the device in a folded position.

FIGS. 5-7 illustrate an alternative embodiment of the device.

In FIGS. 1-4 the device is illustrated with a carrier part 2 fitted over a fork structure 9 which may belong to a hoisting crane, fork lift truck, tractor or other implement carrier. It can be seen in the figures that the carrier part 2 is in the form of one or more sleeves inserted in the fork structures. A holding part 6 is shown mounted at the end of the carrier part 2 and in addition securing devices 1 in the form of magnets are affixed to the holding part 6.

One or more magnets 1 create a magnetic field with a field strength which is such that the forces acting on the object concerned are sufficient to enable the object to be held, lifted and moved. In FIGS. 1-4 the device is equipped with five magnets. The trigger is illustrated here as a guide part 3 in the form of a hinged lever arm which by means of an actuator distances the object in order to achieve release of the object from the magnets 1. In FIG. 1 the guide part 3 is illustrated in a retracted position and in FIG. 2 the guide, part 3 is illustrated in projecting position. As can be seen in FIGS. 1 and 2 the actuator employed for rotating the guide part 3 is composed of a telescopable fork structure. A line 10 is attached to a stationary part of the fork structure 9 by means of a bolt 11. When the fork structure is telescoped outwards, the line will be tightened, thereby causing the guide part 3 to be rotated to a position where an object can be released from the magnets 1.

One or more removable holding edges 4 for extra holding force may be mounted on the holding part 6. The holding edge(s) are designed according to requirements. The holding part 6 may be fixed or suspended in a hinge point 7. If objects require to be lifted from their top surface, the holding part 6 can be swung forwards to a horizontal or other desired position and locked in the desired position. The holding part 6 is illustrated here connected to the carrier part 2 by a hinge 7 in the lower edge. A support structure 5 may furthermore be connected to the holding part 6 and the carrier part 2. The support structure 5 may be attached at the lower edge by a hinge 8 to the carrier part 2.

As illustrated in FIG. 4 the device can be folded up by releasing the connection between the support structure 5 and the holding part 6. The holding part 6 is then laid backwards into a lying position. The support structure 5 is then laid forwards and will lie on top of the holding part 6. On the support structure 5 there may be mounted a protective device which in a folded position will cover the magnet(s) 1 on the holding part 6.

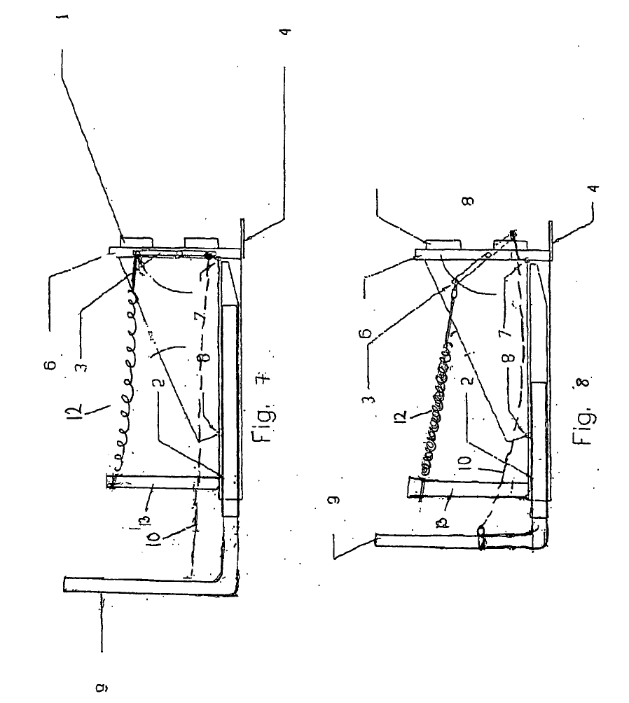

FIGS. 5 and 6 illustrate a principle for alternative rotation of the trigger 3. The device is composed of components corresponding to those illustrated in FIGS. 1-4, but in addition is equipped with a spring 12 attached to a point 3′ on the guide part 3 and to a holder 13 attached to the carrier part 2. In FIG. 5 the forks are illustrated in a retracted state, the spring 12 has pulled the trigger 3 into a position where an object that is fixed to the magnets 1 will be released. In FIG. 6 the forks are illustrated telescoped outwards, the line 10 is taut, the spring is stretched and the guide part 3 is located in a position where the object is still secured.

FIGS. 7 and 8 also illustrate an embodiment of the device equipped with a spring 12 and line 10 corresponding to those in FIGS. 5 and 6, with other components corresponding to that illustrated in FIGS. 1-4. However, in this case the spring 12 is shown attached to the upper part of the trigger 3 and the line 10 attached to the lower part of the trigger 3. In FIG. 7 the forks are illustrated telescoped outwards, the line 10 is taut, the spring is stretched and the guide part 3 is located in a position where the object is secured. In FIG. 8 the forks are illustrated in a retracted state, the spring 12 has pulled the trigger 3 into a position where an object that is fixed to the magnets 1 will be released.

A person skilled in the art will appreciate that many types of spring arrangements will be suitable for achieving the securing and release of the object relative to the securing device according to the invention as indicated in the attached patent. claims.

1. A device for mounting on an implement carrier such as a fork lift truck, hoisting crane or the like in order to move, hold or lift an object, characterised in that the device comprises
a carrier part which is mounted on the implement carrier preferably by the carrier part being in the form of a sleeve which is inserted on the implement carrier's fork structure, and
a holding part which is attached to the carrier part, the holding part being provided with at least one securing device with characteristics that make it possible to secure an object by contact between at least one of the object's surfaces and the securing device,
a trigger that ensures that the forces acting between the object's surface and the securing device are broken or discontinued, thus releasing the object.

2. A device according to claim 1, characterised in that the object that has to be moved, held or lifted is an object with a surface where at least some portions are smooth or an object composed of thin metal sheets, for example of the white goods type.

3. A device according to claim 1,
characterised in that the securing device is one or more electromagnets (1) or permanent magnets (1).

4. A device according to claim 1,
characterised in that the securing device is suction cups or similar devices that can create negative pressure.

5. A device according to claim 1,
characterised in that the trigger is a guide part which is rotatably mounted in the holding part, where on being rotated the guide part pushes the object away from the securing device to a distance which is sufficient for the forces between the object and the securing device to decrease and the object to be released from the holding device.

6. A device according to claim 5,
characterised in that the fork can be telescoped and that there is a fixed connection between a stationary part of the fork and the guide part, so that the guide part will be rotated when the fork is fully extended telescopically.

7. A device according to claim 1,
characterised in that the trigger interrupts the voltage to the electromagnet or causes the negative pressure to be discontinued, thus releasing the object.

8. A device according to claim 1,
characterised in that the trigger is operated manually or by means of an actuator.

9. A device according to claim 1,
characterised in that one or more supporting edges are permanently or removably mounted in the lower edge of the holding part.

10. A device according to claim 1,
characterised in that the holding part is oriented substantially vertically relative to the carrier part and/or that the holding part is mounted rotatably or preferably hingedly on the carrier part, thus enabling the holding part to be moved to another desired position and fixed in this new position.
